(19) United States
(12) Patent Application Publication
(10) Pub. No.: US 2015/0089336 A1
(43) Pub. Date: Mar. 26, 2015

(54) DEVICE AND METHOD FOR MULTISCREEN EXPERIENCE

(71) Applicants: Sanjiv SIRPAL, Oakville (CA); Mohammad SELIM, Oakville (CA); Alex DE PAZ, Burlington (CA); Christine ZIPAY, Burlington (CA); Stephen PASCOE, Burlington (CA)

(72) Inventors: Sanjiv SIRPAL, Oakville (CA); Mohammad SELIM, Oakville (CA); Alex DE PAZ, Burlington (CA); Christine ZIPAY, Burlington (CA); Stephen PASCOE, Burlington (CA)

(73) Assignee: Jamdeo Canada Ltd., Oakville (CA)

(21) Appl. No.: 14/491,612

(22) Filed: Sep. 19, 2014

Related U.S. Application Data
(60) Provisional application No. 61/880,654, filed on Sep. 20, 2013.

(51) Int. Cl. H04L 29/06

(52) U.S. Cl. CPC H04L 65/403
USPC 715/202

(57) ABSTRACT

The present disclosure relates to electronic devices and applications for presentation of content. In one embodiment, a method for presentation of content by a display device includes running a mix application for the display device, the mix application configured to present content during a session and receive content from one or more devices associated with the session. The method also includes presenting a graphical display on the display device during a session initiated by the mix application, wherein the session includes presentation of a plurality of types of content, and receiving content from the one or more devices associated with the session, wherein the content is provided to the display device by the mix application. The method also includes updating presentation of the graphical display to present the content received from the one or more devices associated with the session.

### PRIORITY

This application claims priority to U.S. Provisional Application No. 61/880,654 titled Device and Method for Multiscreen Experience and filed on Sep. 20, 2013, the content of which is expressly incorporated by reference in its entirety.

### FIELD

The present disclosure relates to electronic devices and applications, and more particularly to display and content presentation devices.

### BACKGROUND

Television receivers have long been used to present broadcast TV content. Similarly, television receivers have been used to present video content received from a standalone players. With advances in networking and developments in providing data to end users, there is a need for systems and methods to present content on display devices such as televisions.

### BRIEF SUMMARY OF THE EMBODIMENTS

Disclosed and claimed herein are methods, devices and systems for presentation of content by a display device. One embodiment is directed to a method, the method includes running, by the display device, a mix application for the display device, the mix application configured to present content during a session and receive content from one or more devices associated with the session, and presenting a graphical display on the display device during a session initiated by the mix application, wherein the session includes presentation of a plurality of types of content. The method also includes receiving, by the display device, content from the one or more devices associated with the session, wherein the content is provided to the display device by the mix application, and updating presentation of the graphical display to present the content received from the one or more devices associated with the session.

In one embodiment, the mix application is configured to initiate the session and provide presentation of content shared by participant devices with the display device during the session.

In one embodiment, the session is predefined time period for presentation of content, the session is managed by the mix application.

In one embodiment, the graphical display includes a background image data and a plurality of graphical display areas associated with audio and text content received by the display device for the session.

In one embodiment, the plurality of types of content include image data, audio data, text data, and participant data.

In one embodiment, the content received and presented by the display device is stored on the one or more devices associated with the session.

In one embodiment, the updating presentation includes refreshing the display of content presented by the display device to update one or more of audio, text and image data presented by the display device.

In one embodiment, the method also includes storing a timeline of the session to include a plurality of chips associated with updates of the session, wherein the chips include graphical elements identifying the updated content to the session.

In one embodiment, the mix application is configured to present the session on the one or more devices associated with the session.

Another embodiment is directed to a device configured for presentation of content. The device includes a display unit and a controller coupled to the display unit. The controller is configured to run a mix application for the display device, the mix application configured to present content during a session and receive content from one or more devices associated with the session, present a graphical display on the display device during a session initiated by the mix application, wherein the session includes presentation of a plurality of types of content, receive content from the one or more devices associated with the session, wherein the content is provided to the display device by the mix application, and update presentation of the graphical display to present the content received from the one or more devices associated with the session.

Another embodiment is directed to a system including one or more participant devices, and a display device configured to receive content from the one or more devices by way of a mix application run by the display device. The display device is configured to run a mix application for the display device, the mix application configured to present content during a session and receive content from one or more devices associated with the session, present a graphical display on the display device during a session initiated by the mix application, wherein the session includes presentation of a plurality of types of content, receive content from the one or more devices associated with the session, wherein the content is provided to the display device by the mix application, and update presentation of the graphical display to present the content received from the one or more devices associated with the session.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a simplified system diagram according to one or more embodiments;

FIG. 2 depicts a graphical representation of exemplary features according to one or more embodiments;

FIG. 3 depicts a graphical representation of exemplary features according to one or more embodiments;

FIG. 4 depicts a process for content presentation according to one or more embodiments;

FIG. 5 depicts a process for joining participants to a session according to one or more embodiments;

FIG. 6 depicts a graphical representation of session features according to one or more embodiments;

FIG. 7 depicts a graphical representation of joining a session according to one or more embodiments;

FIG. 8 depicts a graphical representation of active session features according to one or more embodiments;

FIG. 9 depicts a graphical representation of object actions according to one or more embodiments;

FIG. 10 depicts a graphical representation of a session according to one or more embodiments; and

FIG. 11 depicts a graphical representation of a session according to one or more embodiments.

### DETAILED DESCRIPTION OF THE EXEMPLARY EMBODIMENTS

### Overview and Terminology

One aspect of the disclosure relates to presentation of content by a display device, and in particular content associated with a session of a mix application. A mix application, as used herein, relates to an executed application that may be stored on a display device to provide a session based solution to sharing content from user devices to a display device, presentation of content by the display device, and one or more graphical presentations of content during a session. The mix application may be run by a software system of a display device. The mix application may provide a dedicated space on a display device for users to share music, image and text content in the context of a session. The mix application can also allow for companion devices to share content resident on the companion devices with the mix application run by a display device. Features of the mix application on a display device may differ from features of a companion device for one or more of the presentation format and features available.

Sessions of the mix application relate to one or more predefined periods of time for presenting content by a display device. Each session may include presentation of content by the display device, wherein the content of the session and presentation order are based on interactions of users with the mix application of the display device. Sessions may be copied by the mix application and stored to allow for playback. In other embodiments, sessions may be arranged as a timeline for navigating, playback, review and/or sharing of content associated with the session.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

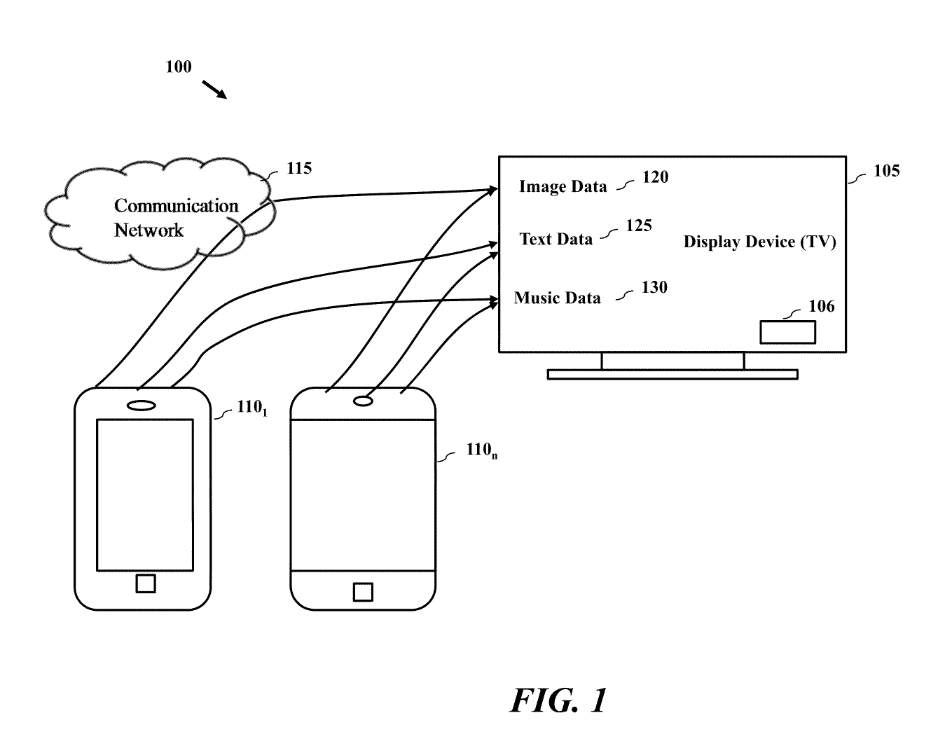

Referring now to the figures, FIG. 1 depicts a simplified system diagram of system 100 according to one or more embodiments. System 100 may be configured for presentation of content by a display device, and in particular content associated with a session of a mix application. As shown in FIG. 1, system 110 includes display device 105 which is configured to receive content from one or more devices associated with a mix application, such as devices 110₁₋ₙ by way of communication network 115. According to an exemplary embodiment, content received by display device 105 includes image data 120, text data 125, and music data 130 (e.g., audio, artist name, album, song name, etc.).

Display device 105 may be a television. In one embodiment, display device 105 includes a controller 106 to run a mix application. Controller 106 coupled to the display unit of display device 105. In one embodiment, controller 106 is configured to run a mix application for the display device 105, the mix application configured to present content during a session and receive content from one or more devices, such as devices 110₁₋ₙ, associated with the session. Controller 106 may also present a graphical display on the display device during a session initiated by the mix application, wherein the session includes presentation of a plurality of types of content. According to another embodiment, controller display device 105 is configured to receive content from the one or more devices associated with the session, wherein the content is provided to the display device by the mix application, and update presentation of the graphical display to present the content received from the one or more devices associated with the session.

Devices 110₁₋ₙ may be one or more participant devices that may be associated with the session by the mix application. According to one embodiment, devices 110₁₋ₙ may be mobile electronic devices configured to run a mix application. Devices 110₁₋ₙ may each include a display and interface to allow for presentation of a session, and transmission of content.

According to one embodiment, the mix application of display device 105 may be run from a dedicated space of the software of display device 105 for the rendering and activation of mix sessions. The dedicated space may allow for operation of the mix application separate from other functions of the display device.

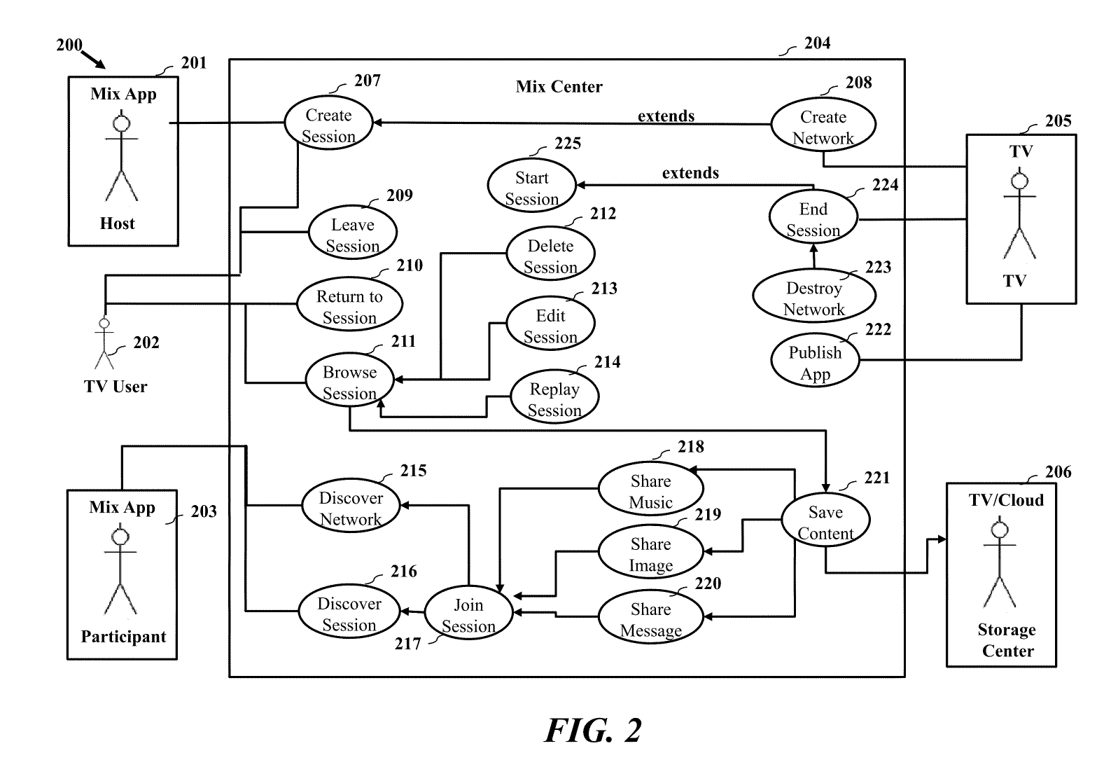

FIG. 2 depicts a graphical representation of exemplary features of the mix application on a display device according to one or more embodiments. According to one embodiment, a mix application 200 of a display device (e.g., display device 105) may support a plurality of features relative to one or more participants/users. As shown in FIG. 2, a mix application host 201 relates to the mix application of a display device (e.g., TV) 205. TV user 202 relates to a user of a display device 205. Mix application participant relates to one or more participants or devices for providing and sharing content with the mix application. Mix center 204 relates to features of the mix application. Data for a session may be provided to and stored by storage center 206.

Features of the mix application 200 are shown in mix center 204. Create session 207 allows for an active session to be started which receives and processes requests from the mix application on a companion device 203. A participant may be added to a session by sending a request from mix app host 201 to companion device 203. Mix application host 201 can receive requests to play music content from content on a companion device 203, and receive requests to play music content from a media center of the display device. Mix application host 201 can receive requests to play image content from a companion device while the companion device is attached to the same network as the display device, and receive a request to play image data from a media center of the display device. Mix application host 201 can receive a request to play text content from the companion device while the companion device is attached to the same network as the display device, and to review image stream history and present previously displayed image content. Mix application host 201 can store session content (image, music metadata, text) sent to the session for user 202 to access and optionally share at a later time.

A mix application run by a companion device host 203 can provide companion device host 203 with specific controls for participating in a session hosted by mix application 201. The mix session may be a sharing session with a defined start and end time. A mix application run by a companion device host 203 can allows guest devices or companion devices to discover and join an active session. A mix application run by a companion device host 203 can join the network of the display device 205 and add songs to a playback queue, the available songs based on the content resident on the guest device or available to the display device 205. A mix application run by a companion device host 203 can send a message and/or picture to the display device 205 to allow users from within the same local network to send text messages and/or pictures to display device 205. A mix application run by a companion device host 203 can also allow for a live photo stream to allow users to join the network of the display device 205 and live stream photos to the display device 205. The display device 205 may save the photos as part of a mix album that can be later viewed by the user.

Mix center 204 relates to a part of the display device 205 for rendering content created during a session of the mix application. Create session 207 provides a means for a user 202 to create a session. In one embodiment, the session needs to be defined by host 201 before guests can join an event and share media content. Create session 207 allows for user 202 to navigate to a mix center 204 of display device 205, receive a request to create a session, and allow for the user 202 to provide one or more of a session name, date and start time, duration, if the user wants to save content during the session, if the user wants to create a network 208 for the session, for user 202 to provide a network name and password, and for the user 202 to select a default music source (e.g., playlist from a media center). If user 202 attempts to define a session during a period where another session is already defined, the user shall be given an option to either modify the current definition or delete the previously defined session. Create session 207 also allows for a user to save a session. Following create session 207, the session is created and available to be started. Create session 207 may restrict the user 202 to not schedule more than one session at a time and can also allow that content can be saved to a connected USB thumb-drive or associated cloud storage 206. Create session 207 may be available to mix application on display device 205 or companion device 203.

Following the operation of create session 207, a user may leave the session 209 or return to a created session 210. Leave session 209 allows for a user to leave a session while the session is in progress. Based on an indication by user 202 to display device 205 to navigate away from the session, mix center 204 pauses the active content, saves the current state (e.g., current view, visible message, images, playlist, etc.) and can switch to live TV. Return to session 210 allows for seamless switch between activates of the display device 205 to allow for the display device to resume presentation of a session.

Create network 208 allows for the display device 205 to create a network for the duration of the session. Mix application participants must be on the same network to participate in a session according to one embodiment. By providing means for the display device to act as a Wi-Fi access point, separate home Wi-Fi is not needed to host a session.

Browse session 211 provides a means for user 202 to browse through future or past sessions, as the user 202 may wish to edit the definition of an upcoming event or replay content from a previous event. Browse session 211 allows user 202 to indicate to display device 205 the desire to browse upcoming or past sessions, view a list of upcoming sessions, past sessions, or select a session. All known sessions will be displayed. In one embodiment, past sessions are only visible after they have been saved and the storage center 206 is available.

Delete session 212 allows the session and all content and metadata to be deleted in response to a user indication of delete and mix center 204 confirmation. Edit session 213 allows for an upcoming session to be edited. Replay session 214 allows for playback of a previously saved session. Hosts may wish to replay a previous session in order to consume text, audio, and image content shared during the session.

Discover network 215 allows for participants to discover a session network. Upon successful connection to a network, the mix application automatically discovers associated session and joins the session. Discover session 216 allows for participants to discover a session. A mix application on companion devices, such as device 203 can scan a network of active sessions, and display a list of all available session and associated display devices to the users of the companion devices. Join session 217 allows for participants to join a session such that the mix application uploads a picture associated with the participant to display device 205. A message may be optionally uploaded from the participant user.

Share music 218 allows for users to share music (e.g., audio, etc.) content on companion devices with other guests of the session. Share music 218 allows for music content to be played on display device 205 and to display one or more of a song name, artist, album, genre, album art, and release year. One or more of the user name and photo may also be shown by display device 205. Share music 218 also allows for content accessible by the display device 205 to be played.

Share image 219 allows for users to take pictures on companion devices during a session and share the photos with other guests during the session by provided in the image data to display device 205. Share message 220 allows for text data, such as commentary or brief statements to be displayed with presentation of the session.

Save content 221 allows for all content associated with the session to be saved. In one embodiment, display device 205 may save data while streaming the session. According to another embodiment, display device may also capture and save one or more of user data (e.g., user name, photo, etc.), music (e.g., song name, artist name, album name, genre, release year, associated message, etc.), image (e.g., EXIF description, geo-location, camera lens, focal length, f-stop, exposure, associated message, etc.), and text (e.g., shared text string, etc.). Save content 221 may obey any DRM restrictions on content if the content is DRM protected, only metadata will be saved. Storage locations including USB thumb drives, cloud storage device 206. IN on embodiment, the display device 205 does not use internal storage for sessions.

Publish App 222 allows for users new to the mix application to download and install the mix application. In response to a user indication of a desire to download the mix application, the mix center 204 provides instructions (e.g., QR code, etc.) to download the mi application appropriate to the display device 205.

Destroy network 223 allows for the display device 205 to cancel a session network after the session have ended.

End session 224 allows user 202 to indicate that it is desired to end the session, end the session by mix center 204, and if necessary disable a network created for the session. End session 224 may be performed automatically by display device 205, such that ten minutes before the end of the session, a warning message may be displayed that the session will soon end. If user 202 does not indicate that they wish to continue or respond, mic center 204 will end the session.

Start session 225 allows for a user 202 to start a session. In one embodiment, an event must be started by host 201 before guests can join the session and share media content. Start session 225 requires that a user 202 has entered mic center 204 or that an event has already been started. Start session 225 allows user 202 to select a session, indicate that they wish to start the session, and if the session was created with a create network flag, create a network at 208. In on embodiment, start session 225 may be automatically started when the start and date time of a session has been reached. For an automatic start, the display device 205 will switch to the mix center 204 and create a network at 208 if necessary.

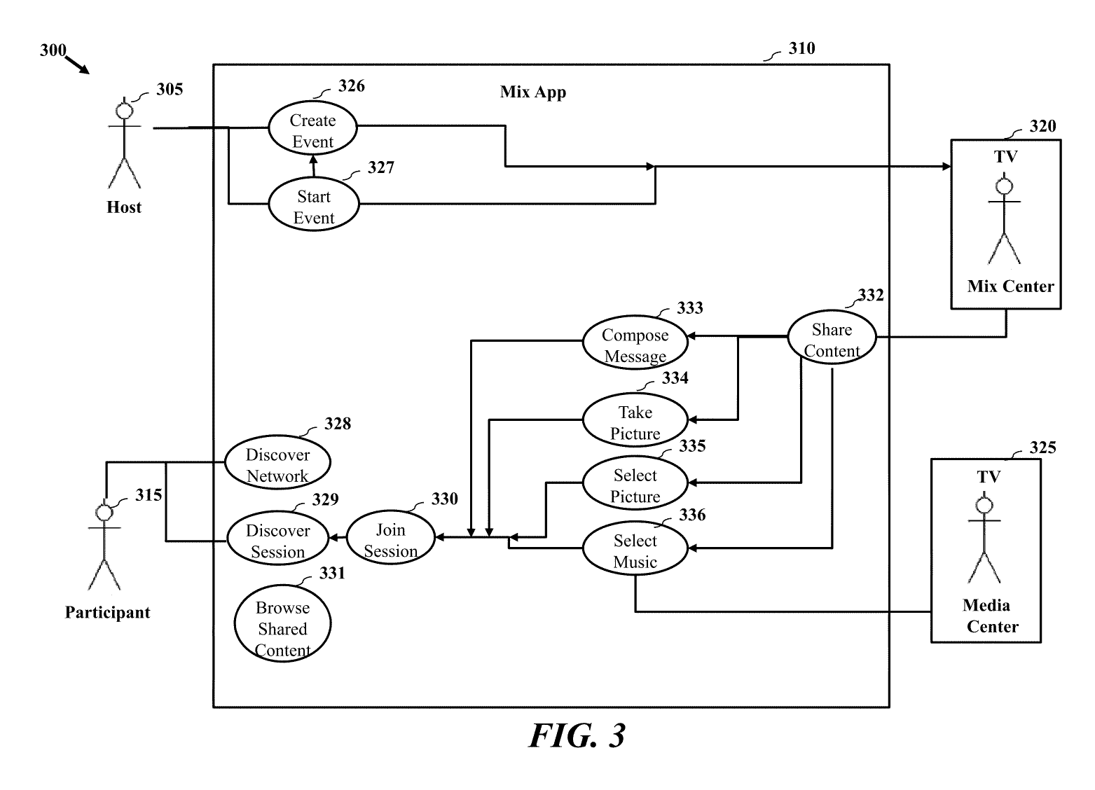

FIG. 3 depicts a graphical representation of exemplary features of a mix application according to one or more embodiments. Mix application features 300 allow for session management and session participation using a companion device. FIG. 3 shows host 305, mix application 310, participant 315, display device 320 and media center 325. Create event 326 allows host 305 to create a mix session. Start event 327 allows for host 305 to initiate sessions created by create event 326 which can then be presented by display device 320. Create event 326 and start event 327 allow for similar features to those described above with respect to create session 207 and start session 225.

Discover network 328 allows for participant 315 to discover a session network. Upon successful connection to a network, the mix application 310 automatically discovers an associated session and joins the session. Discover session 329 allows for participants to discover a session. A mix application 310 can scan a network of active sessions, and display a list of all available session and associated display devices to the users of the companion devices. Join session 330 allows for participant 315 to join a session such that the mix application uploads a picture associated with the participant to display device 320. A message may be optionally uploaded from the participant user.

Browse shared content 331 allows for the mix application to display a list of all content shared to the display device 320. Browsing may be provided for the content itself (image, text, etc.) metadata for the content and a timestamp of when the content was shared.

Share content 332 allows for one or more forms of content, such as messages, pictures and music to be displayed by display device 320. Compose message 333 allows for text data, such as commentary or brief statements to be composed and sent for display by display device 320 during presentation of the session. Take picture 334 allows the user to take pictures on companion devices during a session (e.g., take a picture of themselves, such as a selfie, etc.) share the photos with other guests during the session by provided in the image data to display device 320.

Select picture 335 allows for users to select pictures accessible by display device 320, such as image data stored in media center 325. Take pictures on companion devices during a session and share the photos with other guests during the session by provided in the image data to display device 205. S

Select music 336 allows for users to share music (e.g., audio, etc.) content on companion devices with other guests of the session. Share music 336 allows for music content to be played on display device 320 and to display one or more of a song name, artist, album, genre, album art, and release year. One or more of the user name and photo may also be shown by display device 320. Select music 336 allows for music to be selected from either a companion device of music accessible from media center 325.

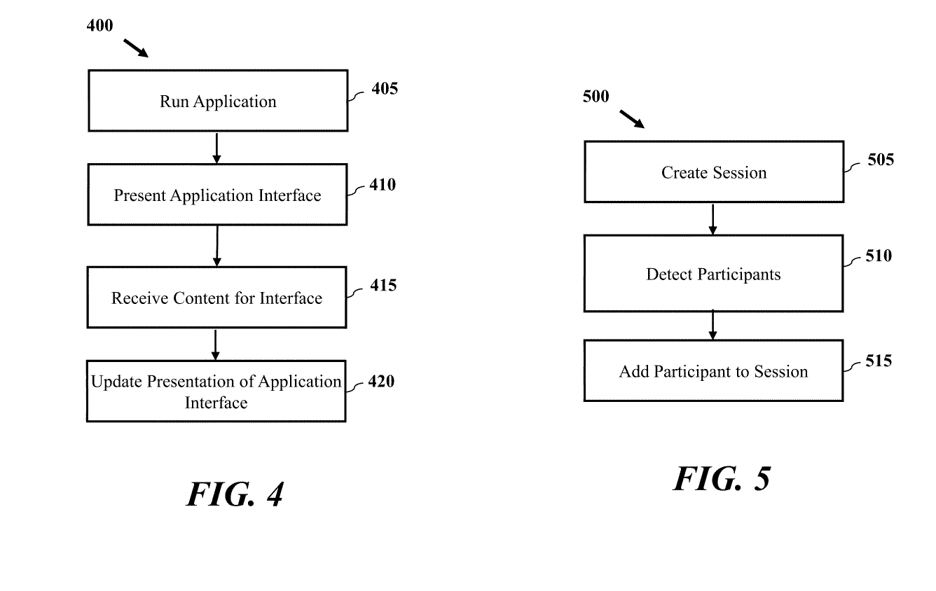

FIG. 4 depicts a process for content presentation according to one or more embodiments. Process 400 may be configured to present content by a display device, and in particular a session associated with a mix application. The mix application may be configured to initiate the session and provide presentation of content shared by participant devices with the display device during the session.

Process 400 may be initiated by a display device running a mix application for the display device at block 405. According to one embodiment, the mix application may be configured to present content during a session and receive content from one or more devices associated with the session at block 405. The session is predefined time period for presentation of content and the session is managed by the mix application. The mix application is configured to present the session on the one or more devices associated with the session.

At block 410, a graphical display is presented on the display device during a session initiated by the mix application, wherein the session includes presentation of a plurality of types of content. The graphical display includes a background image data and a plurality of graphical display areas associated with audio and text content received by the display device for the session.

At block 415 the display device receives content from the one or more devices associated with the session. In one embodiment, content is provided to the display device by the mix application. The plurality of types of content include image data, audio data, text data, and participant data. Content received and presented by the display device is stored on the one or more devices associated with the session.

At block 415 the presentation of the graphical display is updated to present the content received from the one or more devices associated with the session. Updating presentation includes refreshing the display of content presented by the display device to update one or more of audio, text and image data presented by the display device.

Process 400 may additionally include storing a timeline of the session to include a plurality of chips associated with updates of the session, wherein the chips include graphical elements identifying the updated content to the session.

FIG. 5 depicts a process for joining participants to a session according to one or more embodiments. Process 500 may be performed following creation and initiation of a session by a mix application. Process 500 may be initiated by a mix application for the display device creating a session at block 505. At block 510, the mix application can detect one or more participants at block 510. At block 515, participants may join the session.

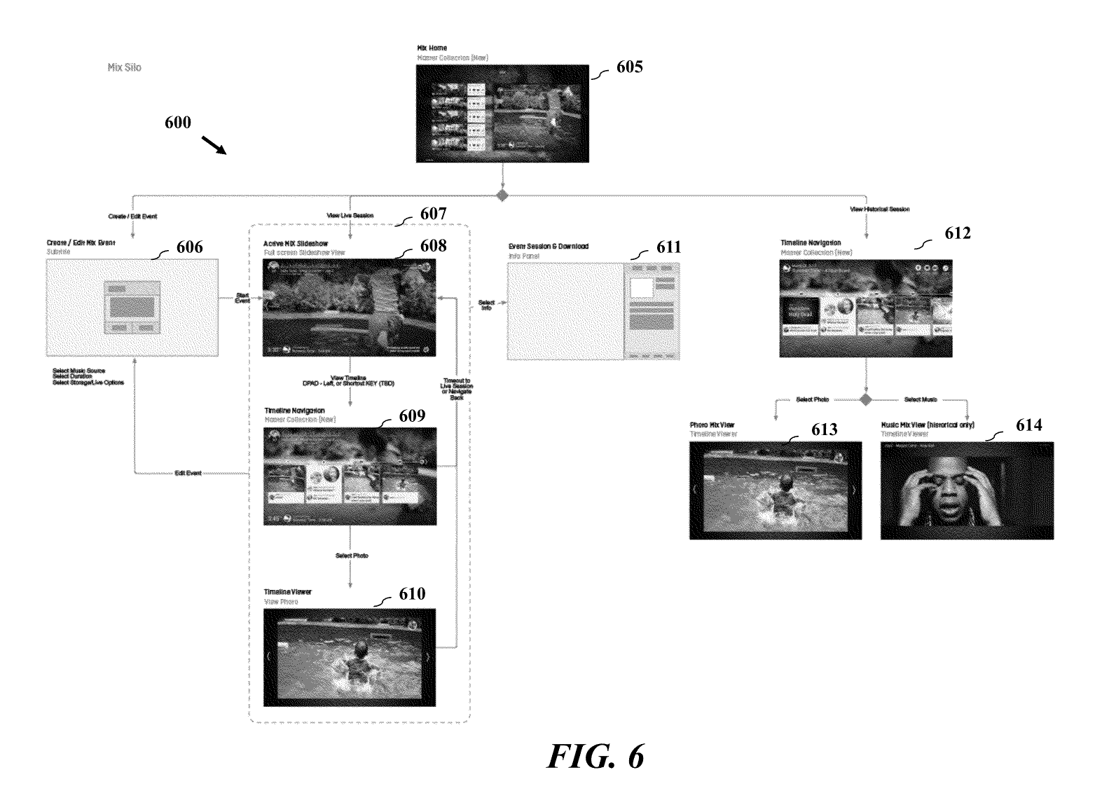

FIG. 6 depicts a graphical representation of session features according to one or more embodiments. According to one or more embodiments, a mix session may be presented with one or more configurations to allow for presentation of data before, during and after a session. FIG. 6 depicts graphical representations 600 associated with a mix silo. A mix silo can refer to the particular portion or operational mode of a display device. The mix silo also is associated with operation of the mix application. Mix home 605 relates to a home screen or presentation to great users of a mix application. Create/edit display 606 relates to a graphical menu for creating a session.

Session 607 relates to one or more display configurations that may be presented during a live session and can include one or more of an active mix slide show 608, timeline navigation 609 and timeline viewer 610. The mix application may also provide a session and download display 611 to allow for management and storing of session data.

The mix application may allow for viewing of a historical session, such as timeline navigation 612 which further allows for viewing image data in a slideshow as presented during the session at 613 and/or music view 614 providing image and music data associated with music during a session.

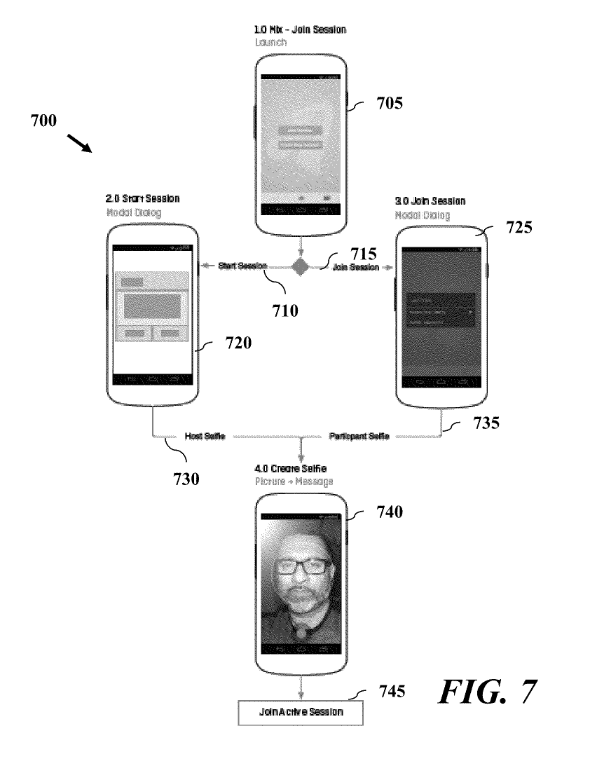

FIG. 7 depicts a graphical representation of joining a session according to one or more embodiments. Process 700 allows for one or more participants to join a session of a mix application. Process 700 may be initiated on a companion device to launch a mix application at 705. The companion device can start a new session at 710 or join an existing session at 715. Presentation on a companion device at 720 allows the user to create a session and can request a host image (e.g., selfie) at 730. Presentation on a companion device at 725 allows the user to join an existing session and can request a host image (e.g., selfie) at 735. At 740, the user may capture an image of themselves and then join the session at block 745. The image data may be used to populate or identify data presented by a display device during a session.

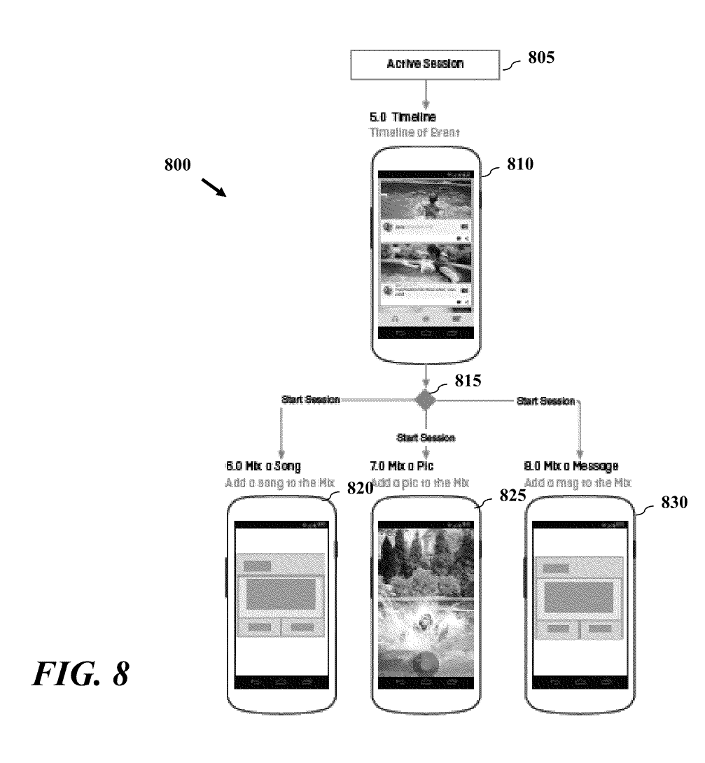

FIG. 8 depicts a graphical representation of active session features according to one or more embodiments. Process 800 allows for one or more types of content to be provided to a session of a mix application. Process 800 may be initiated on a companion device to join an active session of a mix application at 805. The companion device can present a timeline view of the session at 810. At 815, the mix application can allow for one or more types of content to be shared with a display device. Music, such as a song, songs, or album, may be selected and shared at 820. Image data may be shared at 825. Message data, such as a brief text string, can be shared at 830.

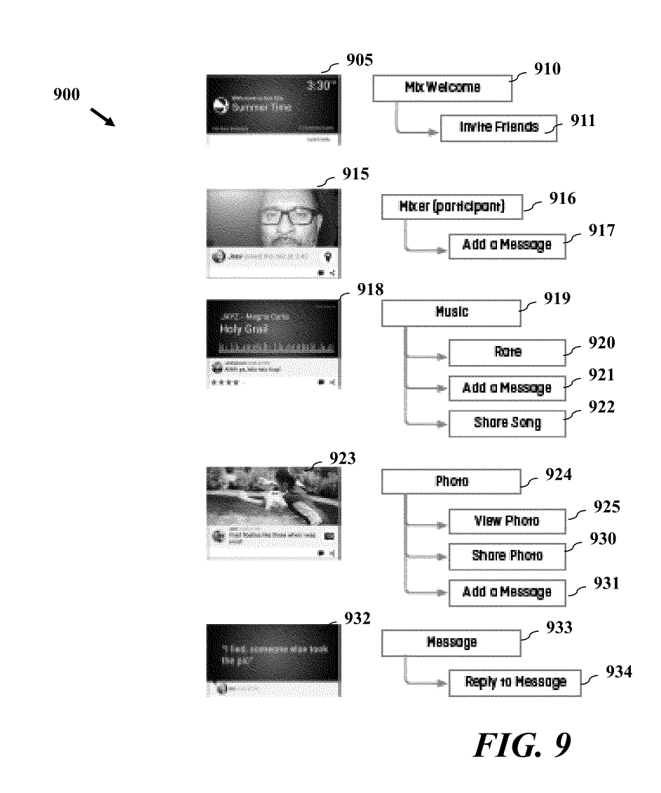

FIG. 9 depicts a graphical representation of object actions according to one or more embodiments. Actions 900 relate to one or more functions that can be perfumed by a mix application on a display device or on a companion device. Each action may relate to a modification or update of the presentation of the session by the mix application. Each action may be displayed as a part or across the entirety of the session.

Welcome screen 905 is presented by the mix application to present a welcome message 910 and allow for friends to be invited at 911. Participant screen 915 is presented by the mix application to present image data for the participant 916 and allow for the participant to add a message 917.

Music block 918 is presented by the mix application to present music 919 that is either selected by or shared by the user. Music 919 may allow for participants to rate 920, add a message 921, and/or share the song 922. Image representation 923 is presented by the mix application to present a photo 924. Photo 924 may allow for participants to view 925, share a photo 930, and/or add a message 931. Message display 932 is presented by the mix application to message 933 and allow for a reply to the message at 934.

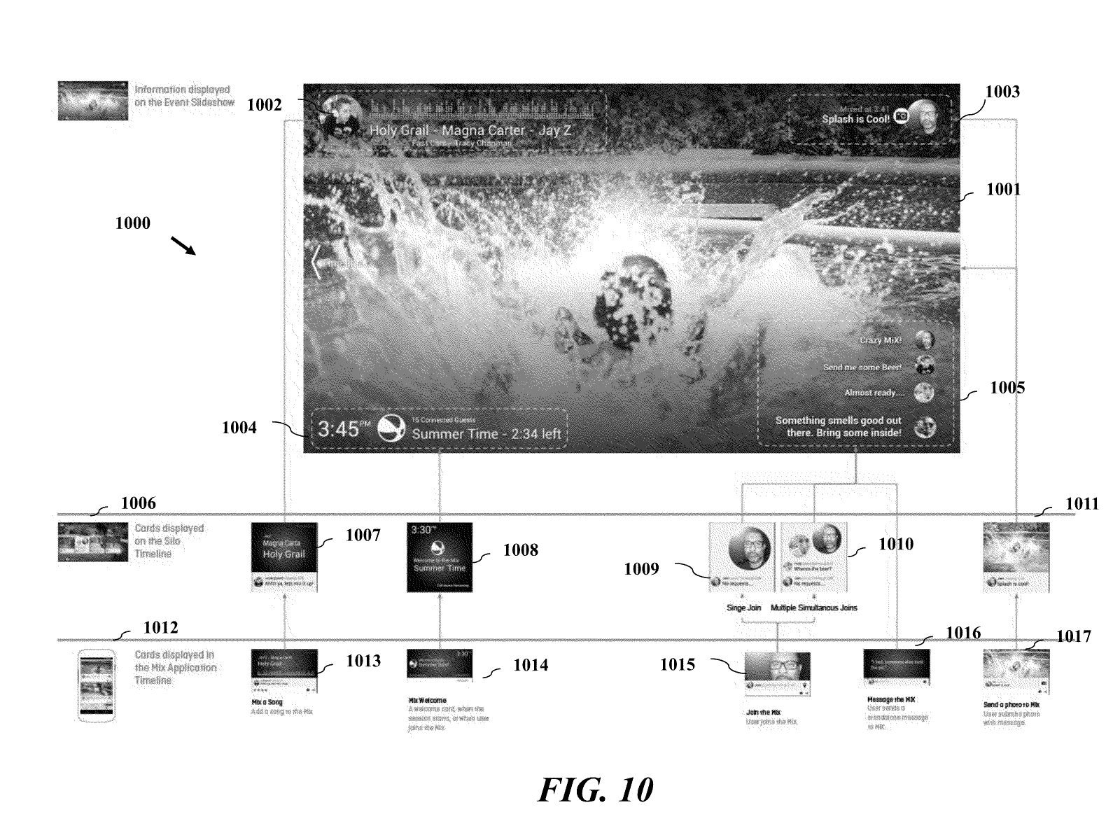

FIG. 10 depicts a graphical representation of a session according to one or more embodiments. Presentation 1000 is an exemplary representation of information and content that may be provided by the mix application during a session. The mix application may display an image 1001 as a background image, music block 1002 to identify music output by the mix application and/or a user that selected the music, text commentary shown as 1003 and 1005 and an informational block 1004. Text commentary 1003 may relate to a comment by a user regarding image 1001. Text commentary 1005 may relate to a comment by a user regarding general messages during the session. Text commentary shown as 1003 and 1005 may additionally be accompanied with image data of the participants that submitted the comments. Informational block 1004 can provide one or more of the time, event name and time left in the session.

According to one embodiment, information and content displayed during the session may be presented as cards or chips during a timeline representation. Cards representative of the mix application on the display device 1006 may include card 1007 identifying the music track by name, card 1008 identifying the session informational block, card 1009 representative of a single join to the session, card 1010 representative of a multiple join to the session, and card 1011 representative of a comment on image 1001. Cards representative of the mix application on the companion device 1012 may include card 1013 identifying the music track by name, card 1014 identifying the session informational block, card 1015 representative of a single join to the session, card 1016 representative of a message sent to the mix application, and card 1017 representative of a comment on image 1018.

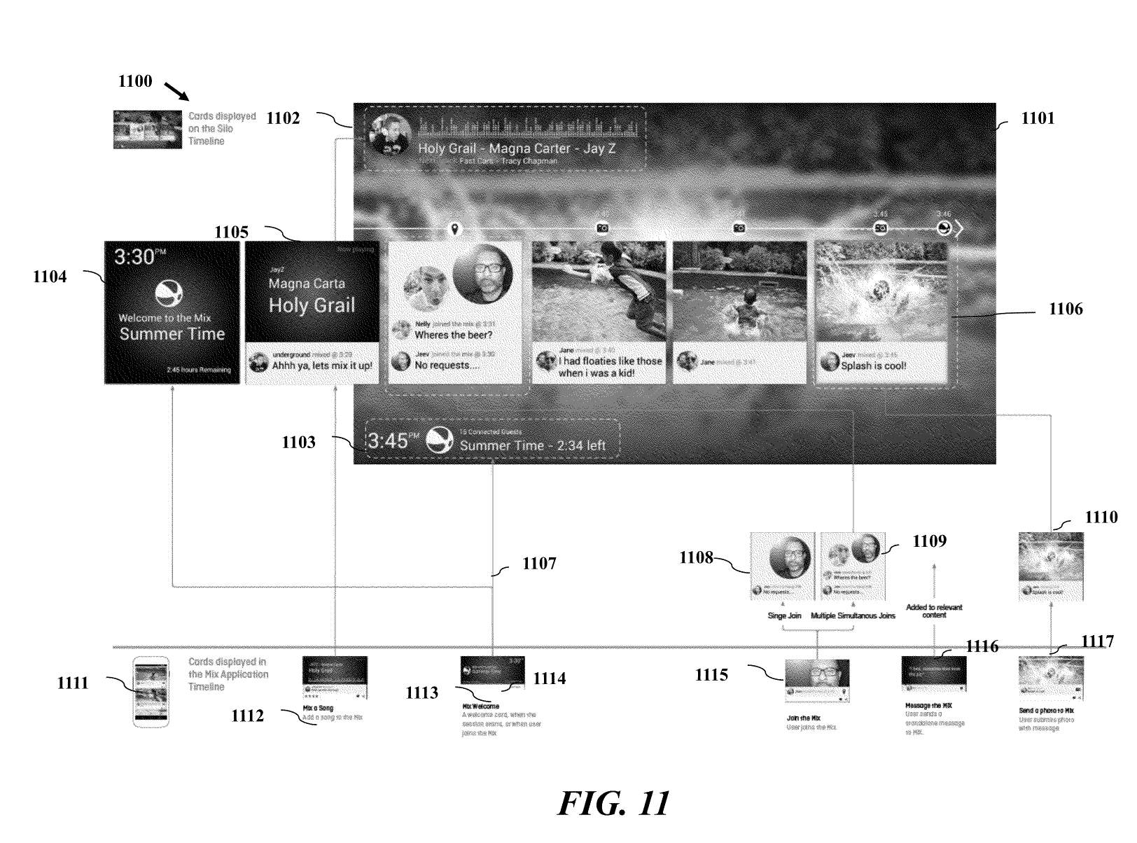

FIG. 11 depicts a graphical representation of a session according to one or more embodiments. Presentation 1100 is an exemplary representation of cards presented by the mix application during a timeline representation. The mix application may display an image 1101 as a background image, music block 1102 to identify music output by the mix application and/or a user that selected the music, cards shown as an informational block 1103, and 1104, 1105 and 1106. According to one embodiment, timeline view of presentation 1100 allows for a user to browse the history of a session, review comments and/or experience content of the session.

Cards of the timeline may be presented with one or more graphical attributes that may be different than a display device mix application on companion device applications. The mix application may output at 1107 cards for a companion device shown as 1111. Cards 1108 and 1109 relate to a single join and multiple join of users to the mix application, respectively. Card 1110 relates to a card 1106 associated with an image and comment data for the image.

Companion device cards 1111 may include card 1112 associated with music block 1102, and card 1114 having message 1113 associated with welcome message card 1104. Text commentary 1103 may relate to a comment by a user regarding image 1101. Text commentary 1105 may relate to a comment by a user regarding general messages during the session. Text commentary shown as 1103 and 1105 may additionally be accompanied with image data of the participants that submitted the comments. Informational block 1104 can provide one or more of the time, event name and time left in the session.

Card 1115 relates to a single join of a user to the mix application. Card 1116 relates to a message to the mix application. Card 11117 is associated with an image and comment data for the image.

According to one embodiment, information and content displayed during the session may be presented as cards or chips during a timeline representation. Cards representative of the mix application on the display device 1106 may include card 1107 identifying the music track by name, card 1108 identifying the session informational block, card 1109 representative of a single join to the session, card 1111 representative of a multiple join to the session, and card 1111 representative of a comment on image 1101. Cards representative of the mix application on the companion device 1112 may include card 1113 identifying the music track by name, card 1114 identifying the session informational block, card 1115 representative of a single join to the session, card 1116 representative of a message sent to the mix application, and card 1117 representative of a comment on image 1118.

While this disclosure has been particularly shown and described with references to exemplary embodiments thereof, it will be understood by those skilled in the art that various changes in form and details may be made therein without departing from the scope of the claimed embodiments.

What is claimed is:

1. A method for presentation of content by a display device, the method comprising:
running, by the display device, a mix application for the display device, the mix application configured to present content during a session and receive content from one or more devices associated with the session;
presenting a graphical display on the display device during a session initiated by the mix application, wherein the session includes presentation of a plurality of types of content;
receiving, by the display device, content from the one or more devices associated with the session, wherein the content is provided to the display device by the mix application; and
updating presentation of the graphical display to present the content received from the one or more devices associated with the session.

2. The method of claim 1, wherein the mix application is configured to initiate the session and provide presentation of content shared by participant devices with the display device during the session.

3. The method of claim 1, wherein the session is a predefined time period for presentation of content, the session is managed by the mix application.

4. The method of claim 1, wherein the graphical display includes a background image data and a plurality of graphical display areas associated with audio and text content received by the display device for the session.

5. The method of claim 1, wherein the plurality of types of content include image data, audio data, text data, and participant data.

6. The method of claim 1, wherein the content received and presented by the display device is stored on the one or more devices associated with the session.

7. The method of claim 1, wherein the updating presentation includes refreshing the display of content presented by the display device to update one or more of audio, text and image data presented by the display device.

8. The method of claim 1, further comprising storing a timeline of the session to include a plurality of chips associated with updates of the session, wherein the chips include graphical elements identifying the updated content to the session.

9. The method of claim 1, wherein the mix application is configured to present the session on the one or more devices associated with the session.

10. A display device configured for presentation of content, the display device comprising:
a display unit; and
a controller coupled to the display unit, wherein the controller is configured to
run a mix application for the display device, the mix application configured to present content during a session and receive content from one or more devices associated with the session,
present a graphical display on the display device during a session initiated by the mix application, wherein the session includes presentation of a plurality of types of content,
receive content from the one or more devices associated with the session, wherein the content is provided to the display device by the mix application, and
update presentation of the graphical display to present the content received from the one or more devices associated with the session.

11. The device of claim 10, wherein the mix application is configured to initiate the session and provide presentation of content shared by participant devices with the display device during the session.

12. The device of claim 10, wherein the session is a predefined time period for presentation of content, the session is managed by the mix application.

13. The device of claim 10, wherein the graphical display includes a background image data and a plurality of graphical display areas associated with audio and text content received by the display device for the session.

14. The device of claim 10, wherein the plurality of types of content include image data, audio data, text data, and participant data.

15. The device of claim 10, wherein the content received and presented by the display device is stored on the one or more devices associated with the session.

16. The device of claim 10, wherein the updating presentation includes refreshing the display of content presented by the display device to update one or more of audio, text and image data presented by the display device.

17. The device of claim 10, further comprising storing a timeline of the session to include a plurality of chips associated with updates of the session, wherein the chips include graphical elements identifying the updated content to the session.

18. The device of claim 10, wherein the mix application is configured to present the session on the one or more devices associated with the session.

19. A system comprising:
one or more participant devices; and
a display device configured to receive content from the one or more devices by way of a mix application run by the display device, wherein the display device is configured to
run a mix application for the display device, the mix application configured to present content during a session and receive content from one or more devices associated with the session,
present a graphical display on the display device during a session initiated by the mix application, wherein the session includes presentation of a plurality of types of content,
receive content from the one or more devices associated with the session, wherein the content is provided to the display device by the mix application, and
update presentation of the graphical display to present the content received from the one or more devices associated with the session.

20. The system of claim 19, wherein the mix application is configured to initiate the session and provide presentation of content shared by participant devices with the display device during the session, and wherein the session is a predefined time period for presentation of content, the session is managed by the mix application.
